(19) United States
(12) Patent Application Publication
(10) Pub. No.: US 2004/0160598 A1
(43) Pub. Date: Aug. 19, 2004

(54) Measuring method for determining the effective light intensity of a pulsed LED light source

(76) Inventor: Dirk Tedeschi, Duelmen (DE)

Correspondence Address: BIRCH STEWART KOLASCH & BIRCH, PO BOX 747, FALLS CHURCH, VA, 22040-0747, US

(21) Appl. No.: 10/775,151

(22) Filed: Feb. 11, 2004

Related U.S. Application Data
(60) Provisional application No. 60/447,738, filed on Feb. 19, 2003.

(30) Foreign Application Priority Data
Feb. 12, 2003 (EP) 03003021.7

(51) Int. Cl. G01J 1/42

(52) U.S. Cl. 356/218

(57) ABSTRACT

In the measuring method for determining the effective light intensity of a pulsed LED light source, considering the physiology of the human eye, a light-sensitive detector measures a multiple pulse light signal emitted by the LED light source. Subsequently, the measured multiple pulse light signal is subjected to integration. The integration is effected on the basis of the form factor method.

### BACKGROUND OF THE INVENTION

1. Field of the Invention

The invention relates to a measuring method for determining the effective light intensity of a pulsed LED light source, the effective light intensity being measured while taking into account the physiology of the human eye and particularly that of the receptors of the human eye.

2. Related Prior Art

For maintenance purposes, it is often required to examine signal light sources with respect to their operatability. As an example for such a signal light source, the warning light (anti-collision light) of aircraft has to be mentioned, which is operated discontinuously and emits light in a pulsed manner.

Discontinuously operated electric discharge lamps as signal light sources produce relatively narrow light pulses with a length of some few milliseconds (5 milliseconds, for example), which, however, are quite luminous (up to 400 cd). For calculating the effective light intensity of the light pulses of such light sources, the known method according to Blondel and Rey is used (SCHMIDT-CLAUSEN HANS-JOACHIM: “COMPARISON OF DIFFERENT METHODS FOR THE DETERMINATION OF THE EFFECTIVE LUMINOUS INTENSITY OF SIGNAL LIGHTS IN THE FORM OF MULTIPLE PULSES” CIE J MAY 1982, volume No. 1, May 1982 (1982-05), pages 18 to 22, XP009007847).

Increasingly, LED technology is used for discontinuously operated light sources. The advantage of LED light sources over electric discharge sources is the longer life and the greater functional reliability in particular. With LED sources, however, only less luminous pulses can be produced than with electric discharge light sources. Therefore, double or multiple flashes are used in LED light sources that are employed as warning lights. To be able to metrologically determine their effective light intensity, the measuring methods according to Schmidt-Clausen cannot be used due to fact that the light pulse intensity is substantially smaller than that of electric discharge lamps.

### SUMMARY OF THE INVENTION

The invention suggest a measuring method for determining the effective light intensity of a pulsed LED light source while taking into account the physiology of the receptors of the human eye, wherein a multiple pulse light signal emitted by the LED light source is measured by means of a light-sensitive detector, the light pulses of which signal are spaced from each other by a time interval shorter than the time for which the afterglow effect of the receptors of the human eye lasts, and the measured multiple pulse light signal is subjected to integration by an evaluating unit, the integration being performed on the basis of the form factor method.

According to one aspect of the invention, the light pulses have a mutual time interval that is shorter than 140 ms, preferably shorter than 100 ms and particularly shorter than 50 ms.

According to another aspect of the invention, the duration of the pulses amounts to at least 100 ms, preferably at least 150 ms.

The inventive measuring method for calculating the effective light intensity of a double or multiple light pulse of a LED light source is based on the physiology of the human eye. Here, the reaction of the receptors to looking at discontinuous LED light sources with respect to the brightness perception is also considered. It is assumed that the eye=s reaction to time-dependent signals is slow. On the one hand, the eye is surprised when looking at the rising edge of the first pulse. To avoid an excessive dazzling, the brightness perception is underrated. The pulse seems to be darker to the viewer. This effect is described by a time constant of 0.2 seconds according to Blondel and Rey (SCHMIDT-CLAUSEN HANS-JOACHIM: “COMPARISON OF DIFFERENT METHODS FOR THE DETERMINATION OF THE EFFECTIVE LUMINOUS INTENSITY OF SIGNAL LIGHTS IN THE FORM OF MULTIPLE PULSES” CIE J MAY 1982, volume No. 1, May 1982 (1982-05), pages 18 to 22, XP009007847). In the course of the pulse duration, the adaptation phase starts and the eye accustoms to the brightness level. The sensitivity of the receptors increases. After the falling edge of the first pulse, an after-glow is perceived. The retina keeps the perceived image so that it is superposed by the next pulse. Experience shows that the afterglow duration lies in the range of 125 ms. When a pulse interval of 20 ms is used, the afterglow effect is- visible. In this time, the perceived luminance decreases only slightly. The double pulse seems to be a bit unsteady, which, however, supports the signal effect upon the viewer. Thus, the double pulse can be metrologically rated as a continuous signal.

### BRIEF DESCRIPTION OF THE DRAWINGS

Some of the above-indicated and other more detailed aspects of the invention will be described in the following description and partially illustrated with reference to the drawings. Therein:

FIG. 1 is a schematic illustration of a double light impulse, the effective light intensity of which has to be calculated,

FIG. 2 is a schematic illustration of a measured double impulse sequence, and

FIG. 3 is a block diagram showing the main features of the invention.

### DESCRIPTION OF A PREFERRED EMBODIMENT OF THE INVENTION

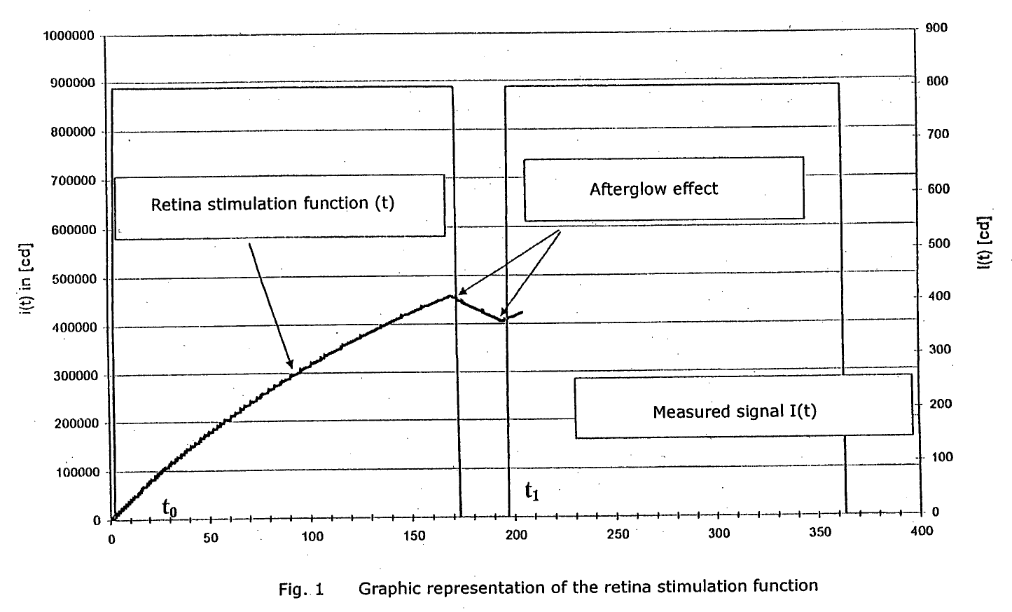

Hereinafter, the reaction of the retina to a light pulse is described mathematically and graphically (FIG. 1). It can be seen therefrom that there is still a stimulation (afterglow effect) after the falling edge of the first pulse. It applies that:

$$i ( t ) = \frac{1}{0.2 s} •exp ( \frac{- t}{0.2 s} ) {\int }_{{t}_{0}}^{{t}_{1}} I ( t ) exp ( \frac{t}{0.2 s} ) ⅆ t$$

where

t=time meter in [s]

I(t)=detected signal in [cd]

i(t) =retina stimulation function in [cd]

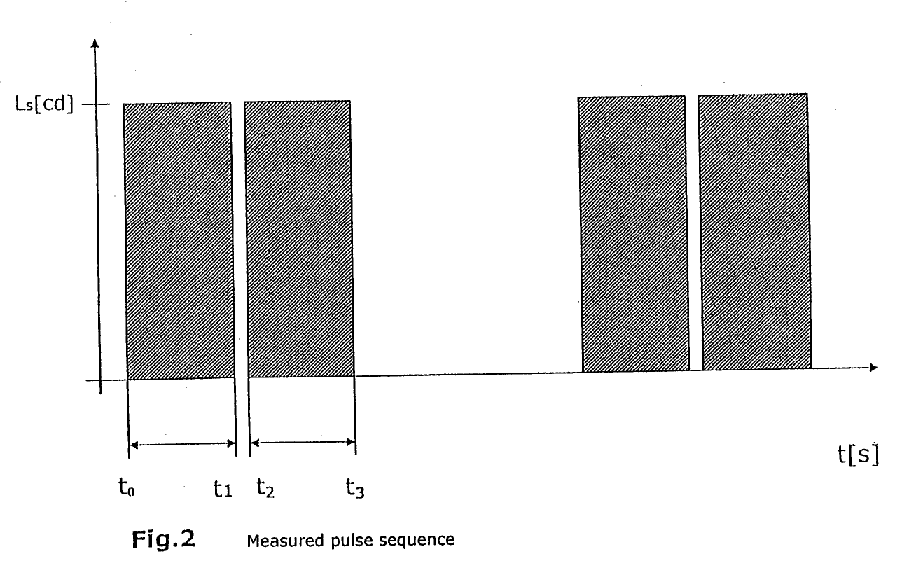

FIG. 2 shows a pulse sequence of a LED light source measured by the detector (in an idealized form). The measuring data resulting therefrom are listed in a table and implemented in the formula set forth herein for determining the effective light intensity.

The formula for determining the effective light intensity on the basis of the form factor method according to Schmidt-Clausen (as to the form factor method, see generally OHNIO Y, NAKANO Y: “MINUTES OF CIE D1 D2 JOINT MEETING” MINUTES OF CIE MEETINGS, Apr. 6, 2000 (2000-04-06), pages 1 to 5 XP002235453 Teddington) is:

$${I}_{eff} = \frac{1}{\frac{C}{{\sum }_{n = 0}^{∞} {\int }_{{t}_{n}}^{{t}_{n + 1}} {i}_{n} ⅆ t} + \frac{1}{{I}_{S}}}$$

$$where$$

$$\begin{matrix}{\sum }_{n = 0}^{∞} {\int }_{{t}_{n}}^{{t}_{n + 1}} {i}_{n} ⅆ t = sum integral of the double pulse ( total width of \\ the double pulse with pulse interval )\end{matrix}$$

I_{S}=maximum value in [cd]

C=constant of Blondel and Rey (c=0.2 s)

The above mathematical term is employed when the directly adjacent pulses can be considered to be approximately continuous while taking into account the afterglow effect of the human eye.

Example of measured values:

| Measuring parameters | Values |
|---|---|
| maximum light intensity | 800 cd |
| Iₛ | |
| ${\int }_{{t}_{0}}^{{t}_{1}} {i}_{1} ⅆ t$ | 120 cds |
| ${\int }_{{t}_{2}}^{{t}_{3}} {i}_{2} ⅆ t$ | 120 cds |

${I}_{eff} = \frac{1}{\frac{0.2 s}{240 cds} + \frac{1}{800 cd}}$
${I}_{eff} = 480 cd$

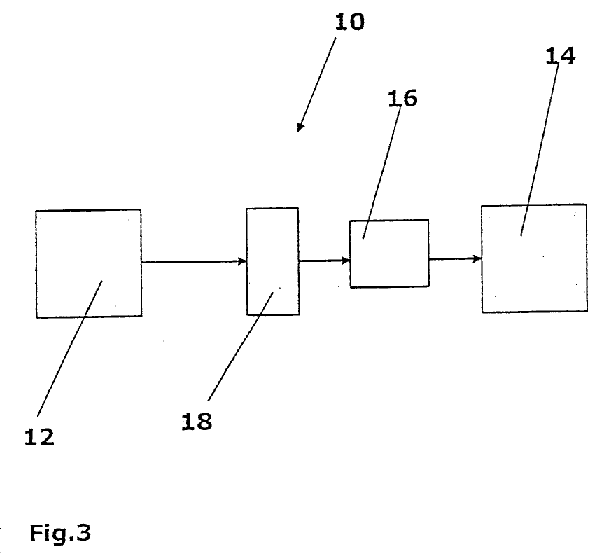

The above-described metrological determination of the effective light intensity of a discontinuously operated LED light source is effected, for example, by a measuring set-up as illustrated in FIG. 3. The measuring apparatus 10 receives the light flashes of a LED light source 12 and comprises an evaluating unit 14 which typically is a microprocessor. The microprocessor 14 is supplied with the output signal of a photodetector 16 upstream of which a filter 18 is connected which only transmits that portion of the light emitted by the LED light source 12 to the detector 16 which corresponds to the spectral light sensitivity of the human eye.

According to the method of the invention, the intensity course of a double or multiple light flash emitted by a LED light source 12 is measured first. Subsequently, the measuring curve is integrated in the evaluating unit 14 while using the above-described form factor method.

The method set forth herein can be used for measuring discrete pulse sequences down to individual pulses of LED light sources regardless of the pulse shape/width. In this context, it has to be noted that the pulse shapes illustrated in FIG. 2 are idealized. In fact, the light intensity of a pulse exponentially decreases from its rising edge to its falling edge to a level below its initial value. Moreover, in the course of the metrological detection, the method according to the invention takes into account the afterglow effect occurring with pulses. Thereby, it is made possible to mathematically combine pulse groups as a uniform signal.

Although the invention has been described and illustrated with reference to a specific illustrative embodiment thereof, it is not intended that the invention will be limited to this illustrative embodiment. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. Measuring method for determining the effective light intensity of a pulsed LED light source, considering the physiology of the receptors of the human eye, wherein
a multiple pulse light signal emitted by the LED light source is measured by means of a light-sensitive detector, the light pulses of which signal are spaced from each other by a time interval that is shorter than the time for which the afterglow effect of the receptors of the human eye lasts, and
the measured multiple pulse light signal is subjected to integration by means of an evaluating unit,
the integration being performed on the basis of the form factor method.

2. The measuring method according to claim 1, characterized in that the light pulses have a mutual time interval that is shorter than 140 ms, preferably shorter than 100 ms and particularly shorter than 50 ms.

3. The measuring method according to claim 1 or 2, characterized in that the duration of the pulses amounts to at least 100 ms, preferably at least 150 ms.
